(19) United States
(12) Patent Application Publication
(10) Pub. No.: US 2016/0030904 A1
(43) Pub. Date: Feb. 4, 2016

(54) DISTRIBUTING SECONDARY SOLIDS IN PACKED MOVING BED REACTORS

(71) Applicant: OHIO STATE INNOVATION FOUNDATION, Columbus, OH (US)

(72) Inventors: Liang-Shih Fan, Columbus, OH (US); Andrew Tong, Columbus, OH (US); Dawei Wang, Columbus, OH (US)

(21) Appl. No.: 14/775,044

(22) PCT Filed: Mar. 13, 2014
(86) PCT No.: PCT/US14/25520

§ 371 Date: Sep. 11, 2015

Related U.S. Application Data
(60) Provisional application No. 61/941,825, filed on Feb. 19, 2014.
(60) Provisional application No. 61/875,418, filed on Sep. 9, 2013.
(60) Provisional application No. 61/779,408, filed on Mar. 13, 2013.

(51) Int. Cl. B01J 8/12; B01J 8/24; B01J 8/00; B01J 19/00

(52) U.S. Cl. CPC B01J 8/12; B01J 19/006; B01J 8/125; B01J 8/24; B01J 8/003; B01J 2208/00752; B01J 2208/0084

(57) ABSTRACT

A system and method for distribution and treatment of secondary solids in packed moving bed reactors is provided. The system includes a packed moving bed reactor and a regeneration reactor downstream of the packed moving bed reactor. The packed moving bed reactor having a primary solid introduction section configured to receive a primary solid material, a primary solid constriction section downstream of the primary solid introduction section, a secondary solid inlet, and a mixing section for primary solid material and secondary solid material downstream of the primary solid constriction section. The primary solid constriction section has a recessed zone, wherein the secondary solid inlet is configured to deliver secondary solid material into the packed moving bed reactor at the recessed zone. The regeneration reactor is operable to regenerate the primary solid material reduced in the packed moving bed reactor.

### CROSS REFERENCE TO RELATED APPLICATIONS

This application claims priority to U.S. Provisional Patent Application No. 61/779,408, filed Mar. 13, 2013, entitled “Treatments and Distributions of Solid Fuels In Packed Moving Bed Reactor Systems” (Docket OSU 0081 MA), U.S. Provisional Patent Application No. 61/875,418, filed Sep. 9, 2013, entitled “Systems and Methods for Distribution of Secondary Solids in Packed Moving Bed Reactor” (Docket OSU 0084 MA), and U.S. Provisional Patent Application No. 61/941,825, filed Feb. 19, 2014, entitled “Systems and Methods for Distribution of Secondary Solids in Packed Moving Bed Reactor” (Docket OSU 0081 M2).

### BACKGROUND

1. Field

The present disclosure relates to packed moving bed reactors, and specifically to secondary solid material treatment and/or distribution in a packed moving bed reactor of primary solid material.

2. Technical Background

There is a constant need for clean and efficient energy generation systems. Many of the commercial processes that generate energy carriers such as steam, hydrogen, synthesis gas (syngas), liquid fuels, and/or electricity are based on fossil fuels. Furthermore, the dependence on fossil fuels is expected to continue in the foreseeable future due to the lower costs compared to some renewable sources. Current conversion of carbonaceous fuels such as coal, natural gas, and petroleum coke is usually conducted through a combustion or reforming process. However, combustion of carbonaceous fuels, especially coal, is a carbon intensive process that may emit large quantities of carbon dioxide to the environment and may require significant capital and operational costs. Sulfur and nitrogen compounds may also be generated in this process due to the complex content in coal.

In systems that utilize a packed moving bed reactor, proper distribution of secondary solid materials, such as solid fuel reactants (e.g. biomass, coke, char, coal, solid waste etc), over primary solid materials such as oxygen carrier particles is important to minimize process inefficiencies and reactor volume. The requirement of effective dispersion and distribution of the secondary solid materials in a moving bed system is of particular importance when the moving bed reactor size is large, as in the commercial scale. Standard methods such as sparger rings have been developed to evenly distribute gaseous species through a packed moving bed of primary solid materials. However, no systems or methods have been developed to effectively and directly introduce and distribute a secondary solid material into a packed moving bed of primary solids materials. The minimal movement and void space in a packed bed of primary solid materials pose a major challenge in designing a single point or multipoint secondary solids injection system and/or method for effective radial distribution. Poor distribution of secondary solid materials would result in ineffective utilization of the reactor volume, low primary and secondary solid material conversions, and possibly dangerous system disturbances such as agglomeration of locally concentrated secondary solid material due to sintering, chemical bonding, melting, or other situations of the like.

Previously, binary mixing of primary and secondary solid materials has been performed in fluidized bed and entrained bed reactor systems where the high solid materials movement and void space promote effective axial distribution. Fluidized and entrained bed designs for solid fuel conversion in binary solid material reaction systems have the disadvantage of low solid material residence time and potential short circuiting of secondary solid materials before conversion is complete. Alternatively, utilizing an entrained bed or fluidized bed binary solid distribution zone to indirectly distribute the binary mixture of solid materials prior to the moving packed bed reactor results in an additional operation step increasing the system capital costs. The indirect solid mixing zones require an additional gas feedstock for fluidizing and/or entraining the binary mixture, thus decreasing the overall system efficiency. Additionally, maintaining proper gas-solid circulation in an integrated moving bed chemical looping system with a fluidized or entrained bed binary solid distribution zone poses a major challenge for operation.

Mechanical solid mixing methods such as screw feeders and rotary discs provide a potential means for primary and secondary solid material distribution. However, mechanical mixing methods of solid materials are susceptible to the abrasive and high temperature environment of the reactor system. Therefore, mechanical mixing methods are expected to decrease system efficiency and reliability due to significant downtime requirements for maintenance and repair of the mechanically moving parts.

Additionally, it is desirable to avoid or minimize agglomeration of secondary solid materials before integration with a primary solid material. Conventional processes for secondary solid materials pretreatment to remove or reduce agglomeration tendencies, such as in caking coals, can be divided into 3 main methods and systems; solid material partial oxidation, inert pyrolysis, and chemical wash treatment. Each conventional method and system involves the use of a discrete gas stream independent of product gas streams in the overall process, thus increasing the operating costs. Each conventional method and system utilizes a singular solid materials mixture operation. No systems or methods have been developed for pretreatment of a secondary solid material integrated with a chemical looping system. Additionally, no systems or methods have been developed for binary solid material mixture pretreatment using a fluidized solid agitation agent with the secondary solid material.

Partial oxidation pretreatment of the secondary solid materials requires the use of air and/or oxygen containing gas stream to remove the agglomeration tendencies such as in caking coals. In some instances, the flue gas produced from the pretreatment method can be emitted as a waste gas reducing the overall system efficiency due to loss of unconverted volatiles. Alternatively, the volatiles can be carried with the partially oxidized secondary solid materials in the reactor system for full secondary material conversion. In a chemical looping system, the air or oxygen containing inert gas stream used in partial oxidation pretreatment results in contamination of the carbon dioxide product stream potentially decreasing the system efficiency for carbon capture.

Inert pyrolysis of the secondary solids materials utilizes a high temperature environment for devolatilization of the solid material to remove the agglomeration tendency. The pyrolysis pretreatment operation requires an extended residence time for proper performance due to the lack of oxidizing gases. The pyrolysis gas produced can either be emitted to atmosphere, reducing the system efficiency due to loss of reactive volatile matter, or carried into the secondary solid material conversion system contaminating the product gas stream with the inert gases used in the pretreatment method. Contamination of the system product gas stream results in a reduction in the carbon captures efficiency similar to the partial oxidation pretreatment method.

Chemical wash pretreatment may use gases, liquids, and/or solids to chemically modify the secondary solid material structure to reduce and/or eliminate the agglomeration tendency. Wash pretreatments include materials such as sodium hydroxide and other alkali based solutions or solid materials and gases such as sulfur dioxide. In the case of liquid pretreatment wash, a contaminated wastewater stream is produced requiring extensive energy and costs for its treatment and/or disposal. All wash treatment methods require the use of materials that can contaminate the product gas stream from the chemical looping system requiring additional systems operation and energy to purify the product gas. Alkali based wash pretreatment can result in excessive fouling of product gas conditioning systems such as heat exchanger coolers. Excessive alkali containing secondary solid materials may cause agglomeration in fluidized bed systems such as a circulating fluidized bed combustion process.

Accordingly, a need is present for improved systems and methods for distributing and treating secondary solids in packed moving bed reactors.

### SUMMARY

In accordance with at least one embodiment, a system having a packed moving bed reactor and a regeneration reactor downstream of the packed moving bed reactor is provided. The packed moving bed reactor includes a primary solid introduction section configured to receive a primary solid material operable to be reduced in the packed moving bed reactor. The packed moving bed reactor also includes a primary solid constriction section downstream of the primary solid introduction section, the primary solid constriction section having an outer wall. The packed moving bed reactor further includes a secondary solid inlet. The packed moving bed reactor additionally includes a mixing section for primary solid material and secondary solid material downstream of the primary solid constriction section, the mixing section having an inner wall. The primary solid constriction section projects into the mixing section and forms a recessed zone defined by the volume between the outer wall of the primary solid constriction section and the inner wall of the mixing section, wherein the recessed zone has a cross-sectional area equal to about 25% to about 75% of a cross-sectional area of the mixing section immediately downstream of the recessed zone. Additionally, the secondary solid inlet disposed adjacent or inside the recessed zone, the secondary solid inlet being configured to deliver secondary solid material into the packed moving bed reactor at the recessed zone. The regeneration reactor is operable to regenerate the primary solid material reduced in the packed moving bed reactor

In accordance with another embodiment, a system comprising a packed moving bed reactor and a regeneration reactor downstream of the packed moving bed reactor is provided. The packed moving bed reactor includes a primary solid introduction section configured to receive a primary solid material operable to be reduced in the packed moving bed reactor, a primary solid constriction section downstream of the primary solid introduction section, the primary solid constriction section having a plurality of suspended baffles affixed to a plurality of secondary solid inlets, and a mixing section for primary solid material and secondary solid material downstream of the primary solid constriction section. The suspended baffles form a recessed zone defined by a volume within the suspended baffles, wherein the recessed zone has a total cross-sectional area equal to about 25% to about 200% of a cross-sectional area of the mixing section immediately downstream of the primary solid constriction section. The plurality of secondary solid inlets disposed adjacent or inside the recessed zone of each suspended baffle and configured to support the suspended baffles, the secondary solid inlet being configured to deliver secondary solid material into the packed moving bed reactor at the recessed zone. The regeneration reactor is operable to regenerate the primary solid material reduced in the packed moving bed reactor.

Additional features and advantages of the systems and methods for distribution and treatment of secondary solids in packed moving bed reactors will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a schematic of a system having a packed moving bed reactor and a regeneration reactor depicted in cross-section, according to one or more embodiments shown and described herein;

FIG. 2 is a side cross-sectional view of a packed moving bed reactor with a primary solid introduction section, a primary solid constriction section, and a mixing section, according to one or more embodiments shown and described herein;

FIG. 3 is a side cross-sectional view of a packed moving bed reactor with a primary solid introduction section, a primary solid constriction section, and a mixing section, according to one or more embodiments shown and described herein;

FIG. 4a is a side cross-sectional view of a packed moving bed reactor with secondary solids introduced from the side, according to one or more embodiments shown and described herein;

FIG. 4b is a side cross-sectional view of a packed moving bed reactor with secondary solids introduced from the side at a location where the primary solid constriction section projects into the mixing section, according to one or more embodiments shown and described herein;

FIG. 4c is a top cross-sectional view of a packed moving bed reactor with secondary solids introduced from the side at a location where the primary solid constriction section projects into the mixing section, according to one or more embodiments shown and described herein;

FIG. 5a is a side cross-sectional view of a packed moving bed reactor with secondary solids introduced from the bottom, according to one or more embodiments shown and described herein;

FIG. 5b is a side cross-sectional view of a packed moving bed reactor with secondary solids introduced from the top, according to one or more embodiments shown and described herein;

FIG. 5c is a top cross-sectional view of a packed moving bed reactor with secondary solids introduced from the top or bottom at a location where the primary solid constriction section projects into the mixing section, according to one or more embodiments shown and described herein;

FIG. 5d is a top cross-sectional view of a packed moving bed reactor with secondary solids introduced from the top or bottom at a location where the primary solid constriction section projects into the mixing section, according to one or more embodiments shown and described herein;

FIG. 6a is a side cross-sectional view of a packed moving bed reactor with secondary solids introduced from the side, according to one or more embodiments shown and described herein;

FIG. 6b is a top cross-sectional view of a packed moving bed reactor with secondary solids introduced from the side at a location where the primary solid constriction section projects into the mixing section, according to one or more embodiments shown and described herein;

FIG. 6c is a top cross-sectional view of a packed moving bed reactor with secondary solids introduced from the side at a location where the primary solid constriction section projects into the mixing section, according to one or more embodiments shown and described herein;

FIG. 7a is a side cross-sectional view of a packed moving bed reactor with secondary solids introduced from the bottom, according to one or more embodiments shown and described herein;

FIG. 7b is a side cross-sectional view of a packed moving bed reactor with secondary solids introduced from the top, according to one or more embodiments shown and described herein;

FIG. 7c is a top cross-sectional view of a packed moving bed reactor with secondary solids introduced from the top or bottom at a location where the primary solid constriction section projects into the mixing section, according to one or more embodiments shown and described herein;

FIG. 7d is a top cross-sectional view of a packed moving bed reactor with secondary solids introduced from the top or bottom at a location where the primary solid constriction section projects into the mixing section, according to one or more embodiments shown and described herein;

FIG. 8a is a side cross-sectional view of a packed moving bed reactor with secondary solids introduced from the side, according to one or more embodiments shown and described herein;

FIG. 8b is a side cross-sectional view of a packed moving bed reactor with secondary solids introduced from the top, according to one or more embodiments shown and described herein;

FIG. 9 is a side cross-sectional view of a packed moving bed reactor with secondary solids introduced from the top, according to one or more embodiments shown and described herein;

FIG. 10a is a side cross-sectional view of a packed moving bed reactor with secondary solids introduced from the top, according to one or more embodiments shown and described herein;

FIG. 10b is a side cross-sectional view of a packed moving bed reactor with secondary solids introduced from the bottom, according to one or more embodiments shown and described herein;

FIG. 11 is a side cross-sectional view of a packed moving bed reactor with wall baffles configured to radially mix the primary solid material and the secondary solid material, according to one or more embodiments shown and described herein;

FIG. 12 is a side cross-sectional view of a packed moving bed reactor with split flow configured to radially mix the primary solid material and the secondary solid material, according to one or more embodiments shown and described herein;

FIG. 13 is a side cross-sectional view of a packed moving bed reactor having wall baffles configured to radially mix the primary solid material and the secondary solid material, according to one or more embodiments shown and described herein;

FIG. 14 is a side cross-sectional view of a packed moving bed reactor having wall baffles configured to radially mix the primary solid material and the secondary solid material, according to one or more embodiments shown and described herein;

FIG. 15 is a schematic illustration of a system having a packed moving bed reactor, a pre-treatment reactor and a regeneration reactor depicted in cross-section, according to one or more embodiments shown and described herein; and

FIG. 16 is a schematic illustration of a system having a packed moving bed reactor, a pre-treatment reactor and a regeneration reactor depicted in cross-section, according to one or more embodiments shown and described herein.

### DETAILED DESCRIPTION

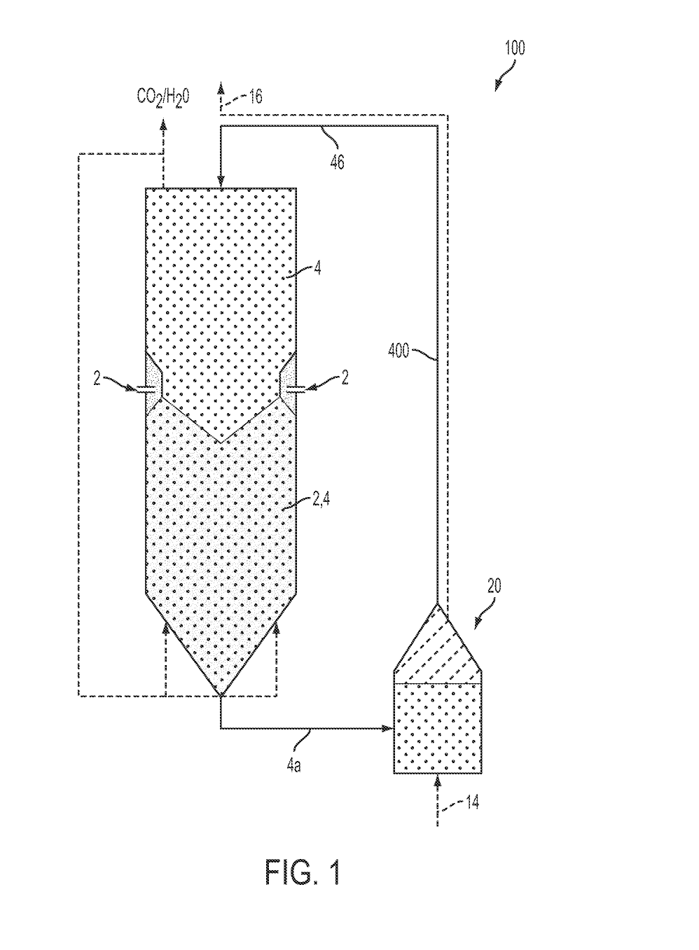

Referring initially to FIG. 1, described herein are systems and methods for distribution and treatment of secondary solid material 2 in a packed moving bed reactor 10. The present disclosure provides systems and methods for pretreating, transporting, dispersing, and evenly distributing secondary solid material 2 directly into a packed moving bed reactor 10 filled with a primary solid material 4. The present systems and methods optimize the primary solid material 4 and secondary solid material 2 utilization and conversion as well as avoid potential system hazards such as agglomeration of the secondary solid material 2, local temperature gradients, and other disruptive phenomenon.

The system 100 comprises a packed moving bed reactor 10 and a regeneration reactor 20 downstream of the packed moving bed reactor 10. The packed moving bed reactor 10 is configured to facilitate introduction of the secondary solid material 2 into the packed moving bed reactor 10 as well as distribution of the secondary solid material 2 throughout the primary solid material 4 disposed in the packed moving bed reactor 10.

Secondary solid material 2, such as biomass, coke, char, coal, and solid waste of both the caking and non-caking types, introduced into the packed moving bed reactor 10 reacts with the primary solid material 4, an oxygen carrier such as a metal oxide. Reactant gas, such as H₂, CO, and/or CH₄, flows from the bottom of the packed moving bed reactor 10 toward the top of the packed moving bed reactor 10. The flow of the gas is indicated by gas flow arrow 200. The primary solid material 4 flows from the top of the packed moving bed reactor 10 toward the bottom of the packed moving bed reactor 10 and the secondary solid material 2 flows from the middle of the packed moving bed reactor 10 toward the bottom of the packed moving bed reactor 10. The flow of the primary solid material 4 and the secondary solid material 2 is indicated by solid flow arrow 300. The reaction results in the primary solid material 4 obtaining a lower oxidation state to form a reduced primary solid material 4a. The reduced primary solid material 4a is discharged from the bottom of the packed moving bed reactor 10 at a lower oxidation state and is transferred into the regeneration reactor 20. In the regeneration reactor 20, air 14 is used to re-oxidize the reduced primary solid material 4a to its original oxidation state to form a regenerated primary solid material 4b. Additionally, air 14 introduced into the regeneration reactor 20 is used to convey the regenerated primary solid material 4b to the packed moving bed reactor 10 for reuse. The resulting gas stream from the regeneration reactor 20 consists of air 14 entirely depleted of, or containing a lower concentration of, O₂ to form depleted air 16.

Embodiments of the present invention make use of a reaction sequence known as chemical looping. A carbon-based fuel such as, for example, coal, is combusted to reduce an oxygen carrier, such as, for example, Fe₂O₃. The carbon-based fuel is the secondary solid material 2 and the oxygen carrier is the primary solid material 4. Thus, the oxidation state of the primary solid material 4 is lowered. In the example using iron oxide (Fe₂O₃) the oxidation state of iron is lowered from +3 to +2.66 (Fe₃O₄), +2 (FeO) or 0 (Fe). The reaction may be expressed as any of the following (unbalanced):

CₓH_{y}+Fe₂O₃→CO₂+H₂O+Fe₃O₄

CₓH_{y}+Fe₂O₃→CO₂+H₂O+FeO

CₓH_{y}+Fe₂O₃→CO₂+H₂O+Fe

where CₓH_{y} is the carbon-based fuel and Fe₂O₃ is the oxygen carrier.

In an embodiment, a solid fuel such as coal is used as the secondary solid material 2. In this embodiment, the primary solid material 4 comprises iron oxide. The iron oxide, in the form of particles/pellets, is introduced into the top of the packed moving bed reactor 10 while the secondary solid material 2 is introduced into a midsection of the packed moving bed reactor 10. Devolatilization products from the secondary solid material 2 react with the primary solid material 4 to form a CO₂ rich flue gas stream. The char/ash formed flows downward along with partially reduced primary solid material 4 as they react to form CO₂ and reduced metal. In this embodiment, the packed moving bed reactor 10 operates at temperatures of between approximately 500° C. and approximately 1200° C. The exhaust H₂O/CO₂ stream may be cooled to condense the water, resulting in a sequestration ready relatively pure CO₂ stream.

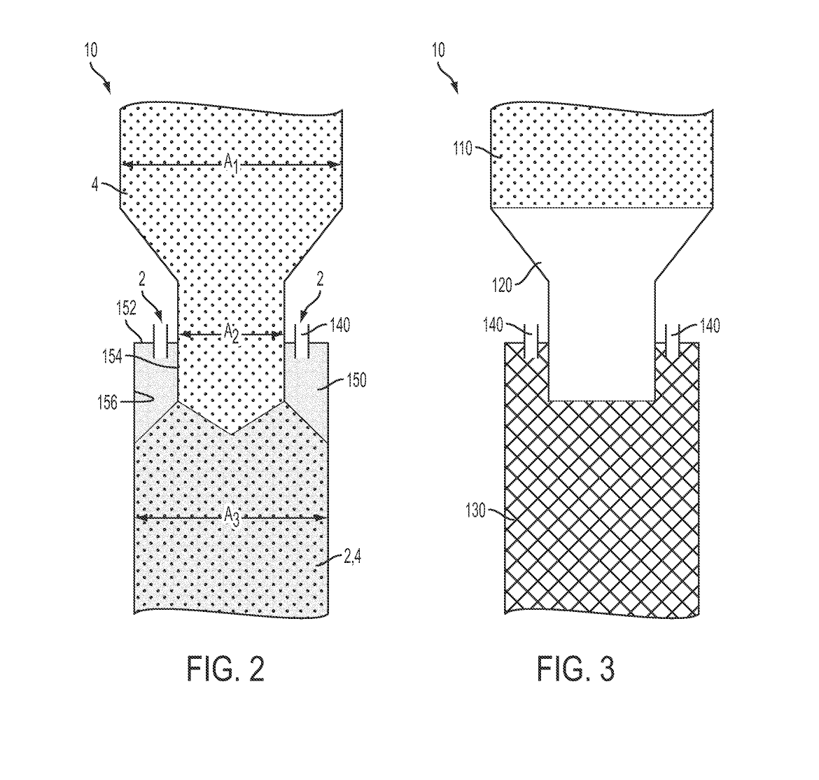

Referring to FIGS. 2 and 3, in an embodiment, the packed moving bed reactor 10 has a primary solid introduction section 110, a primary solid constriction section 120, a mixing section 130, and a secondary solid inlet 140. The primary solid introduction section 110 is configured to receive the primary solid material 4. Immediately adjacent and downstream of the primary solid introduction section 110 is the primary solid constriction section 120. Immediately adjacent the primary solid constriction section 120 is the mixing section 130 which is configured for mixing the primary solid material 4 and the secondary solid material 2. The secondary solid inlet 140 is configured to deliver secondary solid material 2 into the packed moving bed reactor 10.

In an embodiment, the primary solid constriction section 120 projects into the mixing section 130 and forms a recessed zone 150 defined by the volume between the outer wall 154 of the primary solid constriction section 120 and the inner wall 156 of the mixing section 130.

In an embodiment, the recessed zone 150 has a cross-sectional area equal to about 25% to about 75% of a cross-sectional area of the mixing section 130 immediately downstream of the recessed zone 150. The cross-sectional area of the mixing section 130 is defined for the purposes of this disclosure as the cross-sectional area formed by the inner wall 156 of the mixing section 130. In further embodiments, the recessed zone 150 has a cross-sectional area equal to about 25% to about 100% of a cross-sectional area of the mixing section 130 immediately downstream of the recessed zone 150, equal to about 35% to about 85% of a cross-sectional area of the mixing section 130 immediately downstream of the recessed zone 150, and equal to about 45% to about 65% of a cross-sectional area of the mixing section 130 immediately downstream of the recessed zone 150.

In an embodiment, the secondary solid inlet 140 is disposed adjacent or inside the recessed zone 150. Thus, the secondary solid inlet 140 is configured to deliver the secondary solid material 2 into the packed moving bed reactor 10 at the recessed zone 150.

In an embodiment, the secondary solid inlet 140 is operable to deliver secondary solid material 2 by utilizing a carrier gas comprising at least one of CO, CO₂, H₂, H₂O, CH₄, N₂, O₂, He, Ar, and other gases. The carrier gas provides a motive force to transport the secondary solid material 2 and deliver it to the recessed zone 150.

The secondary solid material 2 introduced into the recessed zone 150 must disperse evenly over the primary solid material 4 in the mixing section 130. Preferably, the height of the recessed zone is long enough to ensure the secondary solid material 2 can disperse to fill the recessed zone 150. Generally, the height of the recessed zone 150 may be shortened as an increased carrier gas velocity is used.

As the primary solid material 4 moves downward in the packed moving bed reactor 10, the secondary solid material 2 exits the recessed zone 150 and mixes with the primary solid material 4. In an embodiment, the gas velocity within the mixing section 130 is greater than the minimum fluidization velocity of the secondary solid material 2, but less than the minimum fluidization velocity of the primary solid material 4. This fluidization allows the secondary solid material 2 to become fluidized and propagate across the entire cross sectional area of the mixing section 130. In various embodiments the gas velocity within the mixing section 130 varies from approximately 3 centimeters per second to approximately 1 meter per second.

The concentration gradient, pressure gradient, and packed bed movement of the primary solid material 4 are the driving forces for the radial dispersion of the secondary solid material 2. Based on these driving forces, the secondary solid material 2 disperses evenly over the packed bed of primary solid material 4 if sufficient time and bed height is provided. For purposes of this measurement, the bed height is the length of the mixing section 130, as that represents the length of the packed moving bed reactor 10 available for the secondary solid material 2 to disperse evenly through the primary solid material 4. Further, the greater the available area of the recessed zone 150 for the secondary solid material 2 to disperse over, the faster the distribution of the secondary solid material 2 across the entire cross-section of the packed moving bed reactor 10 can be completed. Faster distribution of the secondary solid material 2 across the entire cross-section of the packed moving bed reactor 10 corresponds to a shorter bed height requirement. Greater radial primary solid material 4 movement through added recessed zones 150 can also increase the radial dispersion of the secondary solid material 2 in a shorter bed height.

In an embodiment, the bed height below the recessed zone 150 is 10% to 400% of the mixing section diameter (A₃) to achieve even secondary solid material 2 distribution. In a further embodiment, the bed height below the recessed zone 150 is 25% to 200% of the mixing section diameter (A₃). In still a further embodiment, the bed height below the recessed zone 150 is 50% to 100% of the mixing section diameter (A₃). In yet still a further embodiment, the bed height below the recessed zone 150 is 100% to 200% of the mixing section diameter (A₃). The necessary bed height depends on the gas and primary solid material 4 velocity in the system 100 as well as the area of the recessed zone 150.

In an embodiment, a cross-sectional area of the primary solid constriction section 120 is less than a cross-sectional area of the mixing section 130. Alternatively, the primary solid constriction section diameter (A₂) is less than the mixing section diameter (A₃). This arrangement produces the recessed zone 150 allowing the secondary solid material 2 to be introduced into the packed moving bed reactor 10. The cross-sectional area difference between the mixing section 130 and the primary solid constriction section 120 is the free volume for secondary solid material 2 introduction.

In an embodiment, a cross-sectional area of the primary solid constriction section 120 is equal to or less than a cross-sectional area of the primary solid introduction section 110. Alternatively, the primary solid constriction section diameter (A₂) is equal to or less than the primary solid introduction section diameter (A₁). In an embodiment, a cross-sectional area of the mixing section 130 is greater than or equal to a cross sectional area of the primary solid introduction section 110. Alternatively, the mixing section diameter (A₃) is equal to or greater than the primary solid introduction section diameter (A₁). The cross sectional area of the mixing section 130 may affect the secondary solid material 2 residence time and gas residence time.

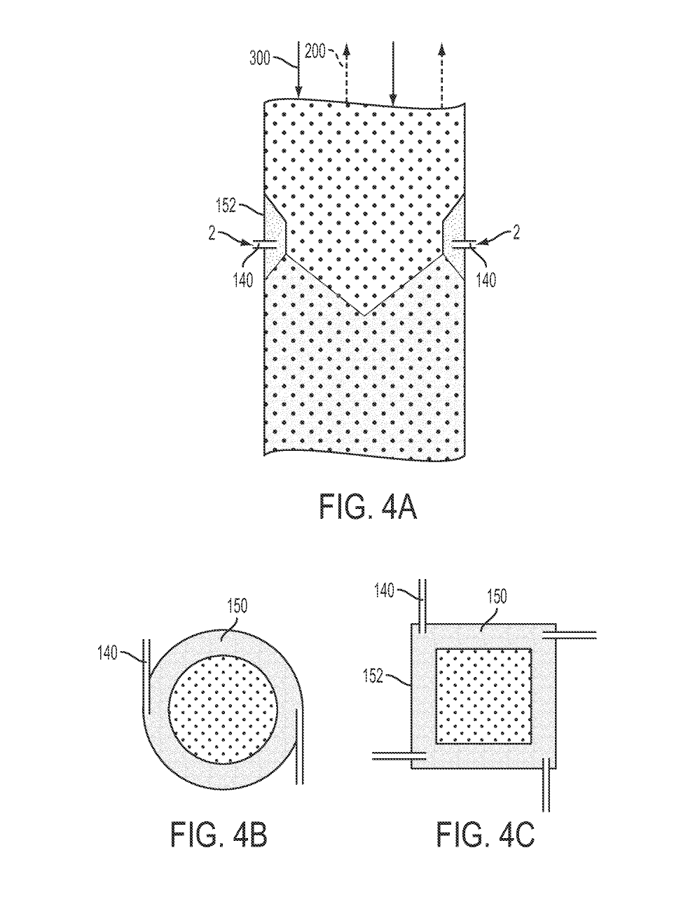

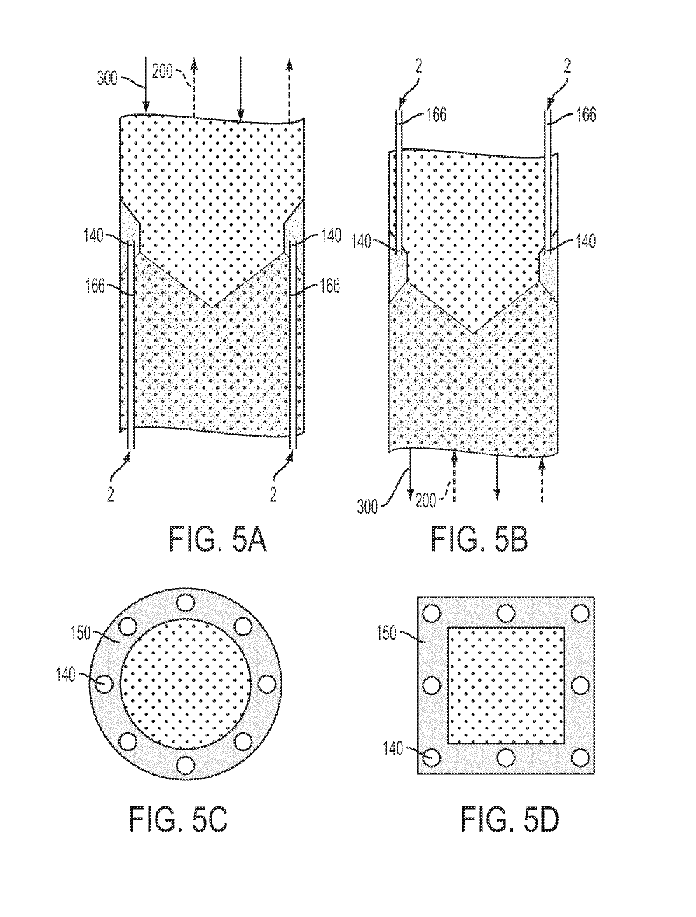

Referring to the embodiments of FIGS. 4a, 4b, 5a, 5b, and 5c, the primary solid constriction section 120 is an annular ring offset from the inner wall 156 of the mixing section 130. This creates a recessed zone 150 which is an annular region around the periphery of the packed moving bed reactor 10.

In various embodiments wherein the primary solid constriction section 120 is an annular ring offset from the inner wall 156 of the mixing section 130, the desired height of the recessed zone 150 is dependent on the placement and number of secondary solid inlets 140. The height must be sufficient to ensure the secondary solid material 2 can disperse over the distance up to the next secondary solid inlet 140. Sufficient height of the recessed zone 150 ensures the secondary solid material 2 from the secondary solid inlet 140 expands to cover the desired surface area of the packed moving bed reactor 10 in the mixing section 130. Generally, the height of the recessed zone 150 is shorter when a higher carrier gas velocity is used.

Referring to the embodiments of FIGS. 4a, 4c, 5a, 5b and 5d, the primary solid constriction section 120 has a polygonal cross section and the mixing section 130 similarly has a polygonal cross section. In a further embodiment, the polygonal cross section of the mixing section 130 and the polygonal cross section of the primary solid constriction section 120 are of equal order. For purposes of this disclosure, polygonal cross sections of equal order are defined as cross sections being formed from polygons with an equal number of sides. For example, two rectangular cross sections or two pentagonal cross sections. Thus, a recessed zone 150 is formed representing a region around the periphery of the packed moving bed reactor 10.

In various embodiments wherein the primary solid constriction section 120 and mixing section 130 have a polygonal cross sections, the desired height of the recessed zone 150 is dependent on the placement and number of secondary solid inlets 140. The height must be sufficient to ensure the secondary solid material 2 can disperse over the distance up to the next secondary solid inlet 140. Sufficient height of the recessed zone 150 ensures the secondary solid material 2 from the secondary solid inlet 140 expands to cover the desired cross-sectional area of the packed moving bed reactor 10 in the mixing section 130. Generally, the height of the recessed zone 150 is relatively shorter when a relatively faster carrier gas velocity is used.

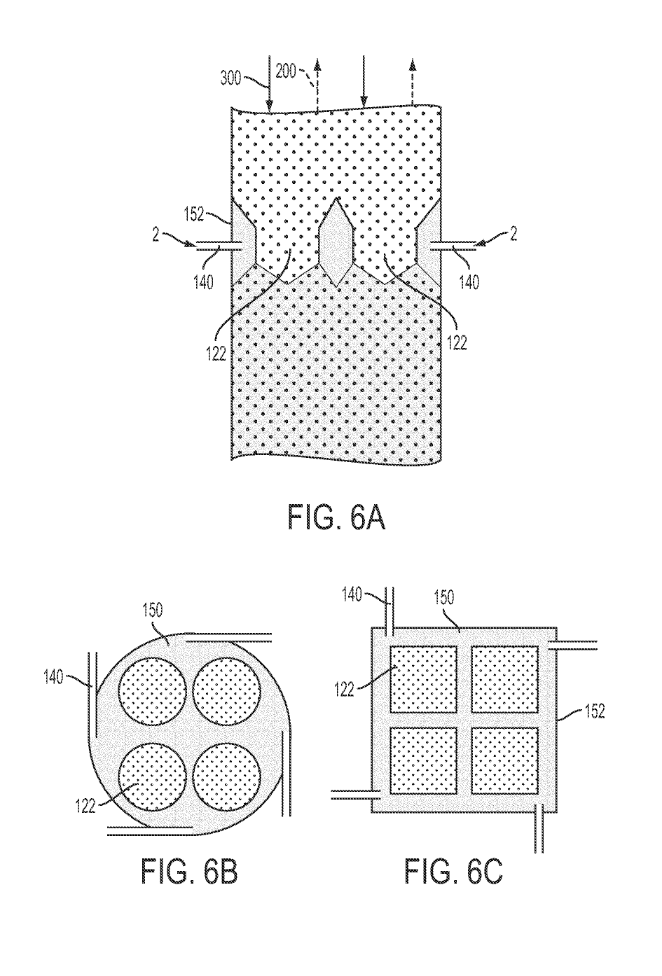

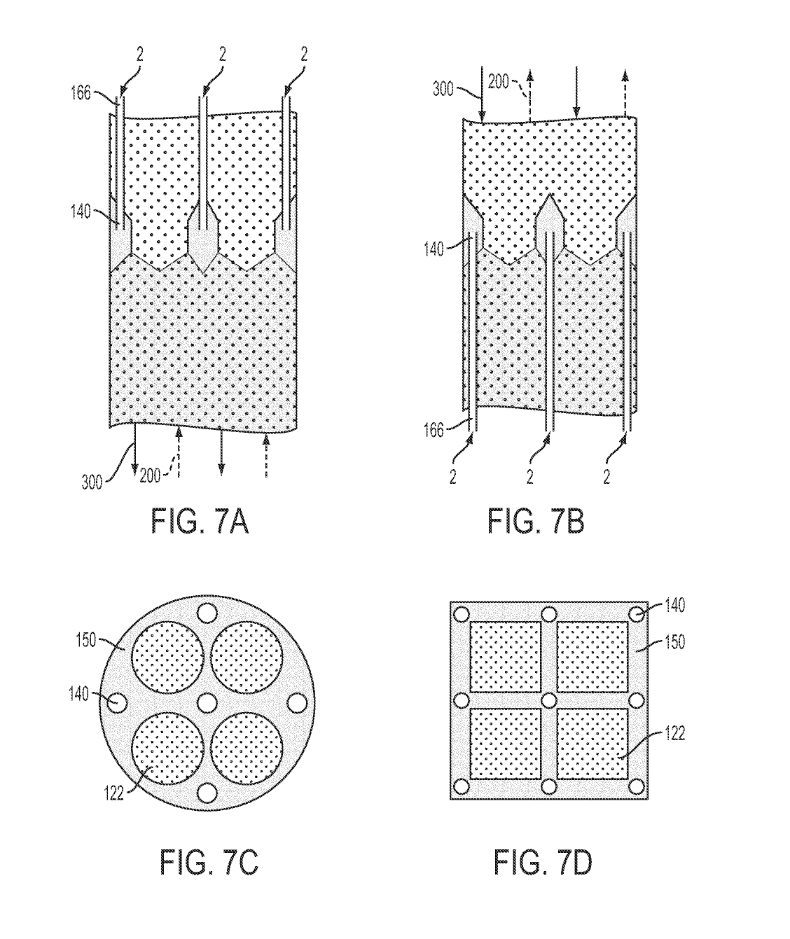

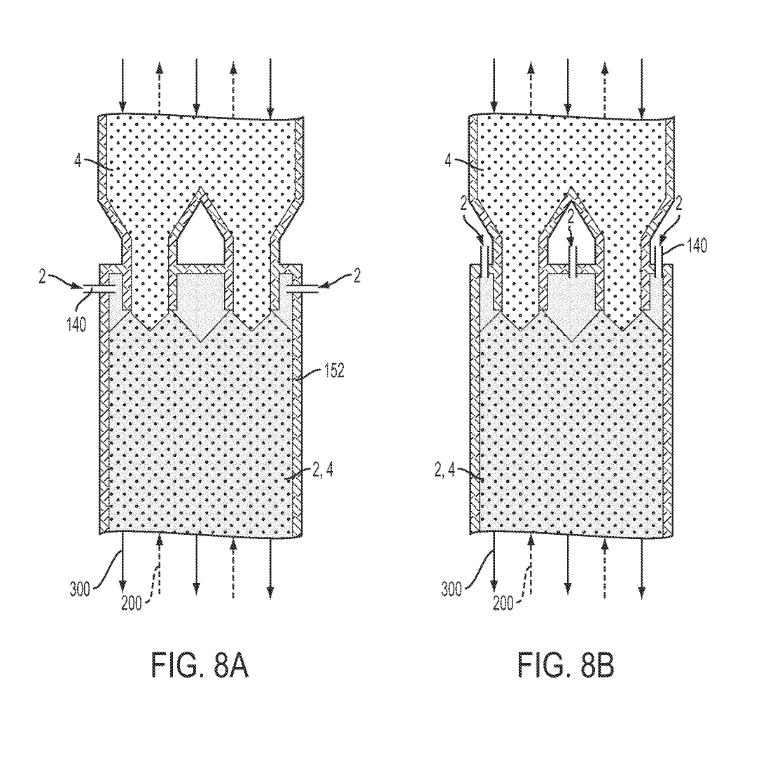

Referring to the embodiments of FIGS. 6a-6c, 7a-7d, and 8a-8b, the primary solid constriction section 120 has multiple diplegs 122 projecting into the mixing section 130. Diplegs 122 are portions of the primary solid constriction section 120 having a cross-sectional area less than that of the mixing section 130 which extend into the mixing section 130. There may be a single dipleg 122 or multiple diplegs 122 in various embodiments. The individual diplegs 122 in various embodiments have cross sectional areas representing circles and/or polygons, for example.

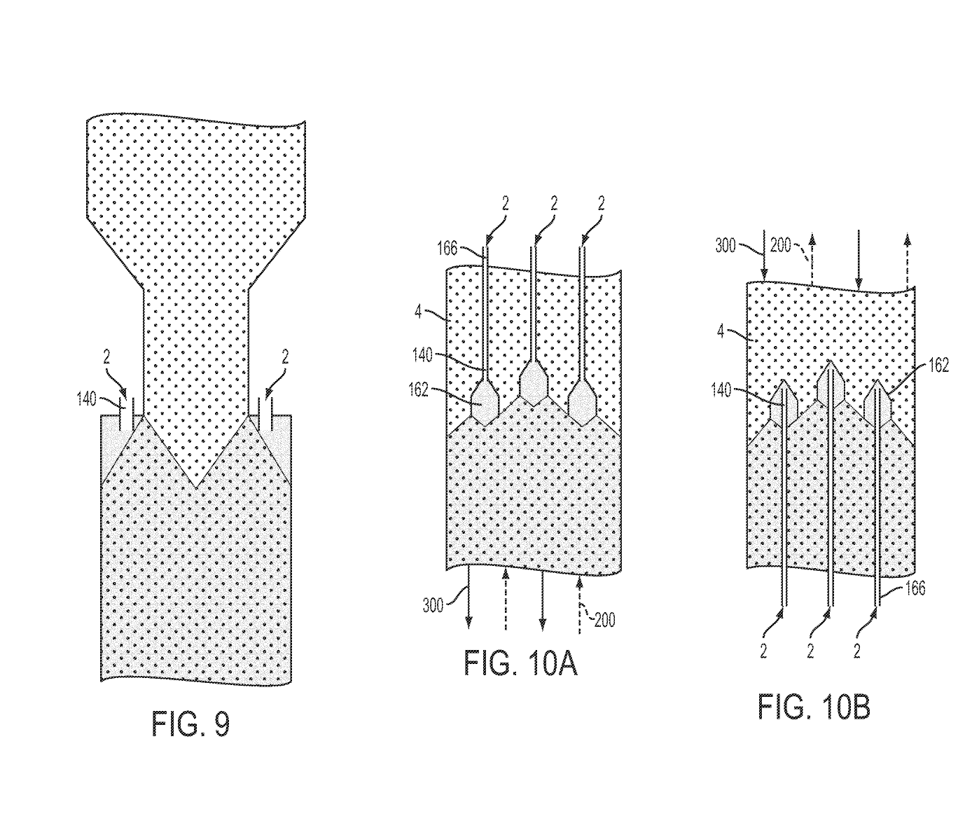

In another embodiment, referring to FIG. 9, no internal dipleg 122 or portion of the primary solid constriction section 120 projects into the mixing section 130. The angle of dispersion of the primary solid material 4 exiting the primary solid constriction section 120 creates a recessed area 150 at the top of the mixing section 130 for the secondary solid material 2 to disperse over. In certain exemplary embodiments, the secondary solid material 2 is introduced from the top of the recessed zone 150 as illustrated in FIG. 9. In other exemplary embodiments, the secondary solid material 2 is introduced from the side and/or a combination of the top and side. In yet another exemplary embodiment, the enclosing wall between the primary solid constriction section 120 and the mixing section 130 is inclined to provide additional height and volume to the created recessed area 150.

Referring to FIGS. 10a and 10b, in various embodiments, the primary solid constriction section 120 has a plurality of suspended baffles 162 affixed to a plurality of secondary solid inlets 140. The suspended baffles form a recessed zone 150 defined by a volume within the suspended baffles 162. In an embodiment, the suspended baffles 162 substantially form an inverted “U” or “V” to create a hooded or covered region which represents the recessed zone 150.

In an embodiment, multiple suspended baffles 162 are suspended from the top, bottom, or walls of the packed moving bed reactor 10. The suspended baffles 162 are placed along or at the end of suspension mounts or piping of the secondary solid inlet 140 to maintain their position in the packed moving bed reactor 10.

In an embodiment, the suspended baffles 162 are all disposed in alignment along a single bed height of the primary solid constriction section 120 of the packed moving bed reactor 10.

In a further embodiment, the suspended baffles 162 are disposed at varying bed heights within the primary solid constriction section 120 of the packed moving bed reactor 10. In an embodiment, the suspended baffles 162 are disposed at different bed heights and are arranged such that when viewed from the top of the packed moving bed reactor 10, the suspended baffles 162 appear to overlap. The location of the suspended baffles 162 along the bed height can vary and radially overlap with other suspended baffles 162.

In an embodiment, the recessed zone created by the suspended baffles 162 disposed in the primary solid constriction section 120 has a total cross-sectional area equal to about 25% to about 200% of the cross-sectional area of the mixing section 130 immediately downstream of the primary solid constriction section 120.

In various embodiments utilizing suspended baffles 162, the necessary height of the recessed zone 150 of each suspended baffle 162 is dependent on the placement and number of secondary solid inlets 140 and suspended baffles 162. The height must be sufficient to ensure the secondary solid material 2 can disperse over the distance up to the next secondary solid inlet 140 and suspended baffle 162. Sufficient height of the recessed zone 150 ensures the secondary solid material 2 from the secondary solid inlet 140 expands to cover the desired surface area of the packed moving bed reactor 10 in the mixing section 130. Generally, the height of the recessed zone 150 is shorter when a higher carrier gas velocity is used or more suspended baffles 162 are utilized.

In various embodiments the packed moving bed reactor 10 is manufactured from refractory, ceramic, metal, or other materials known to one skilled in the art. The material choice of the packed moving bed reactor 10 is dependent on the process operating temperature, pressure, and application. For example, in case of the chemical looping process for the conversion of solid fuel such as coal, the packed moving bed reactor 10 may be made from a ceramic or refractory material to maintain structural integrity at high operating temperatures. Additionally, the walls of the packed moving bed reactor 10, in various embodiments, comprise multiple layers with an air gap disposed between the layers.

Referring to FIGS. 2, 3, 4a-4c, 6a-6c, 8a-8b, 9, 11, 12, and 14, in various embodiments, the secondary solid material 2 is directly introduced into the recessed zone 150 of the packed moving bed reactor 10 through the wall 152 of the packed moving bed reactor 10. The secondary solid inlet 140 passes through the wall 152 of the packed moving bed reactor 10 at a point adjacent the recessed zone 150 such that passage of the secondary solid inlet 140 through the wall 152 disposes the outlet of the secondary solid inlet 140 in the recessed zone 150. In various embodiments, the secondary solid inlet 140 enters the recessed zone 150 from the top and/or side.

Referring to FIGS. 5b, 7a, and 10a, in various embodiments, the secondary solid material 2 is introduced from the top of the packed moving bed reactor 10. In an embodiment, internal pipes 166 in the packed moving bed reactor 10 are used to carry the secondary solid material 2 from the top of the packed moving bed reactor 10 to the secondary solid inlet 140 for introduction into the recessed zone 150. The outlet of the secondary solid inlet 140 is positioned in the recessed zone 150 such that the secondary solid material 2 is disposed into the recessed zone 150.

Referring to FIGS. 5a, 7b, and 10b, in various embodiments, the secondary solid material 2 is introduced from the bottom of the packed moving bed reactor 10. In another embodiment, internal pipes 166 in the packed moving bed reactor 10 are used to carry the secondary solid material 2 from the bottom of the packed moving bed reactor 10 to the secondary solid inlet 140 for introduction into the recessed zone 150. The outlet of the secondary solid inlet 140 is positioned in the recessed zone 150 such that the secondary solid material 2 is disposed into the recessed zone 150.

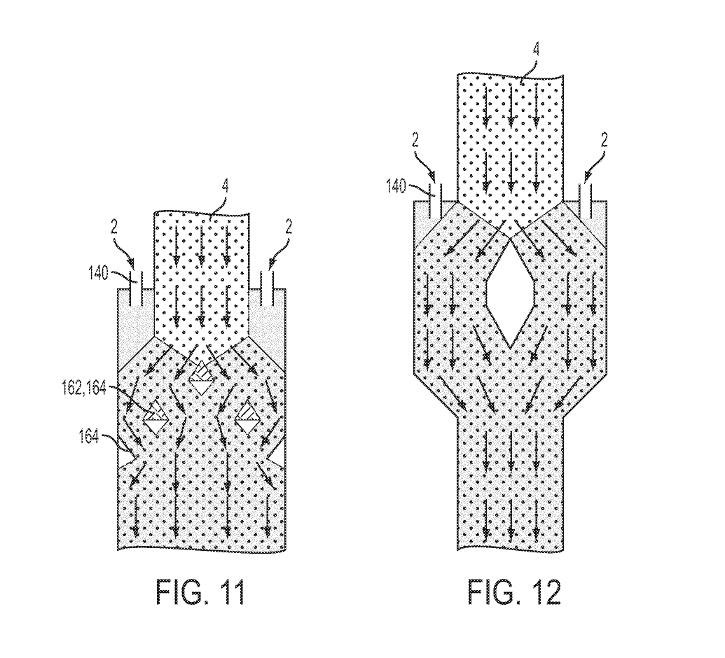

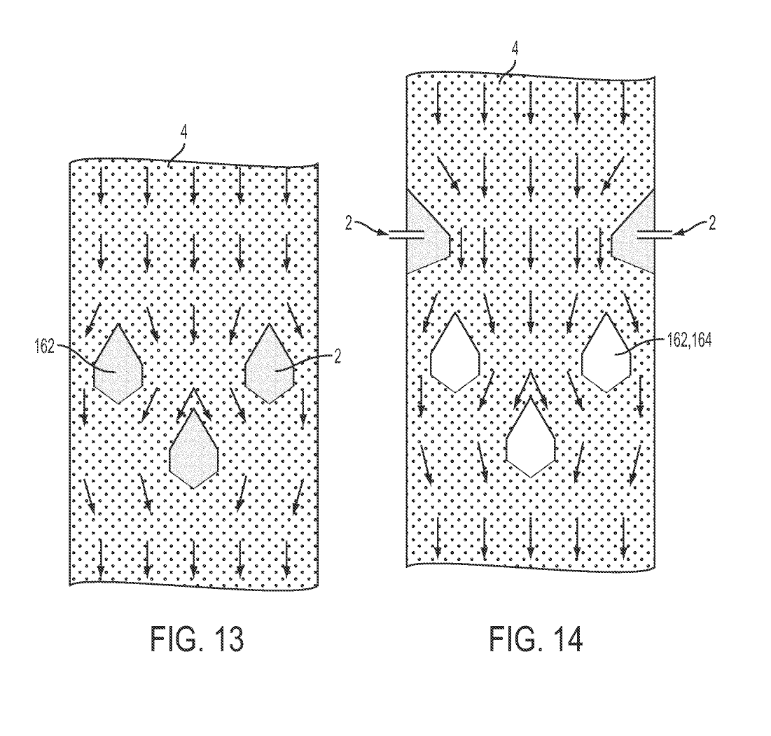

Referring to the embodiments of FIGS. 11, 12, 13, and 14, the mixing section 130 comprises suspended baffles 162 configured to radially mix the primary solid material 4 and the secondary solid material 2. In a further, embodiment, the mixing section 130 comprises wall baffles 164 configured to radially mix the primary solid material 4 and the secondary solid material 2. In still a further embodiment, the mixing section 130 includes both suspended baffles 162 and wall baffles 164. The suspended baffles 162 and wall baffles 164 redirect the radial movement of the primary solid material 4 and the secondary solid material 2 into a zigzag movement, thus generating a more even distribution of secondary solid material 2 throughout the primary solid material 4.

In an embodiment, the suspended baffles 162 in the mixing section 130 substantially form an inverted “U” or “V” and redirect flow through the mixing section 130 to induce mixing of the primary solid material 4 and the secondary solid material 2. In further embodiments, the suspended baffles 162 have a profile of various shapes such as a diamond, triangle, hexagon, or any other shape that does not interfere with the smooth flow of the packed moving bed reactor 10. In yet another embodiment, the suspended baffles 162 in the mixing section 130 are affixed to the inner wall 156 of the mixing section 130 through a support arm (not shown). In a further embodiment, the suspended baffles 162 in the mixing section 130 are supported from above or below through a support arm (not shown) affixed to an interior surface of the packed moving bed reactor 10.

In an embodiment, the wall baffles 164 in the mixing section 130 form angled ledges radiating from the inner wall 156 of the mixing section 130 and redirect flow through the mixing section 130 to induce mixing of the primary solid material 4 and the secondary solid material 2. In further embodiments, the wall baffles 164 include protuberances on the inner wall 156 of the mixing section 130 of the packed moving bed reactor 10.

In further embodiments, the suspended baffles 162 and/or wall baffles 164 are disposed at varying bed heights within the mixing section 130 of the packed moving bed reactor 10. In an embodiment, the suspended baffles 162 and/or wall baffles 164 are disposed at different bed heights and are arranged such that when viewed from the top of the packed moving bed reactor 10, the suspended baffles 162 and/or wall baffles 164 appear to overlap. The suspended baffles 162 and/or wall baffles 164 can be placed inline or staggered, and can have one or more layers along the bed height.

In an embodiment, the total cross sectional area of the suspended baffles 162 and wall baffles 164 in the mixing section 130 is equal to about 25% to about 200% of the cross sectional area of the mixing section 130. In a further embodiment, the total cross sectional area of the suspended baffles 162 and wall baffles 164 is equal to about 50% to about 150% of the cross sectional area of the mixing section 130. In still a further embodiment, the total cross sectional area of the suspended baffles 162 and wall baffles 164 is equal to about 50% to about 100% of the cross sectional area of the mixing section 130. A cross sectional area in excess of 100% is achievable because suspended baffles 162 and wall baffles 164 disposed at differing bed heights in the packed moving bed reactor 10 can have overlapping cross sectional areas.

In further embodiments, the total cross sectional area of the suspended baffles 162 and wall baffles 164 is determined to keep the net cross sectional area of the mixing section 130 for solids flow equal to the cross sectional area of primary solid constriction section 120.

In an embodiment, the regeneration reactor 20 is operable to regenerate the primary solid material 4 reduced in the packed moving bed reactor 10. In various embodiments, the regeneration reactor 20 comprises one or more of a fluidized bed reactor, a moving bed reactor, a rotary kiln, or a series of fluidized beds in co-current or counter current flow.

In an embodiment, the system 100 also includes a recycle loop 400 configured to deliver regenerated primary solid material 4b back to the primary solid introduction section 110.

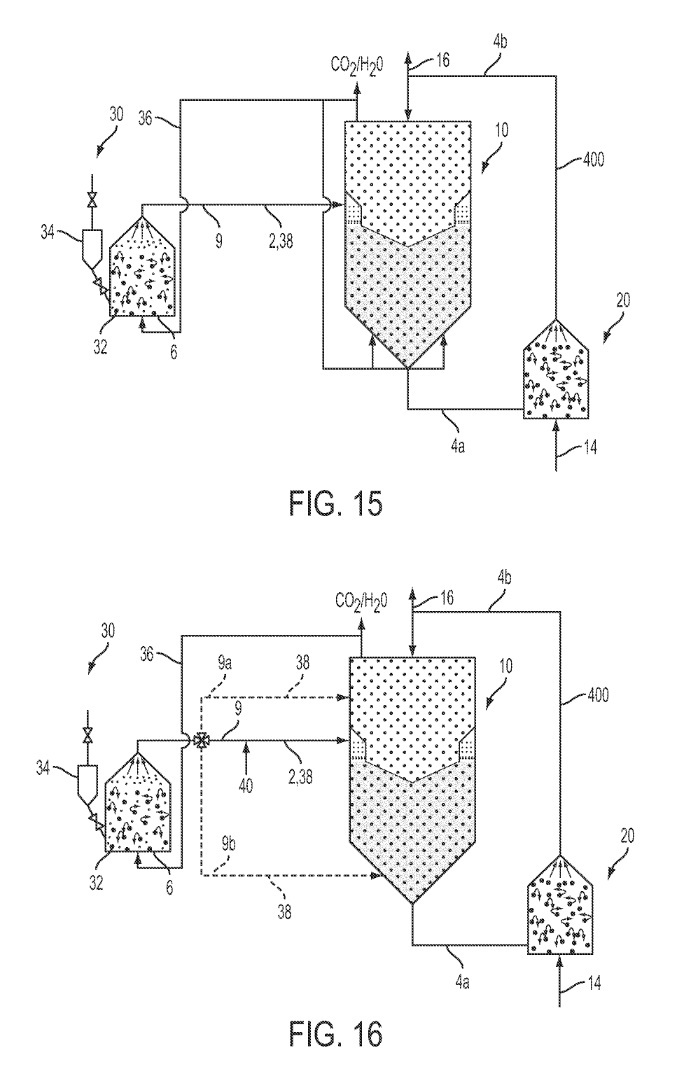

Referring to the further embodiments of FIGS. 15 and 16, the system 100 includes a pre-treatment reactor 30 disposed upstream of the packed moving bed reactor 10. The pre-treatment reactor 30 is configured to fluidize and/or reduce agglomeration in the secondary solid material 2. When the secondary solid material 2 is cohesive or easily forms agglomerates, pretreatment helps to eliminate this property of the secondary solid material 2. For example, with caking coals, pretreatment can heat up the coal particles to devolatilize the coal and change the coal to char to reduce the caking tendencies.

In an embodiment, secondary solid material 2 is fed into a pre-treatment reactor 30. Providing the secondary solid material 2 to the pre-treatment reactor is through conventional means such as a lock hopper system 34, eductor, and other systems known to one or ordinary skill in the art. The solid agitation agent 32 within the pre-treatment reactor 30 is maintained in the fluidized regime to act as an agitation agent. The mixed solid fluidized bed operation prevents defluidization of the pre-treatment reactor 30 by maximizing thermal transfer to the secondary solid material 2 and minimizing contact between secondary solid material 2 particles.

In an embodiment, the pre-treatment reactor 30 comprises one or more fluidizing agents selected from the group consisting of a solid agitation agent 32, a gaseous agent 36, or both.

In an embodiment, the gaseous agent 36 is a recycled product stream from the packed moving bed reactor 10. In another embodiment, the gaseous agent 36 consists predominately of CO₂ and H₂O. For example, the gaseous agent 36 may be comprised of at least 80% CO₂ and H₂O, at least 90% CO₂ and H₂O, at least 95% CO₂ and H₂O, at least 99% CO₂ and H₂O, at least 99.9% CO₂ and H₂O, or even at least 99.99% CO₂ and H₂O. In a further embodiment, the gaseous agent 36 comprises at least one of CO, CO₂, CH₄, O₂, N₂, He, and Ar.

With reference to FIGS. 15 and 16, the pre-treated secondary solid material 2 overflows or is carried out of the pre-treatment reactor 30 with the pre-treatment exhaust gas stream 38 from the pre-treatment reactor 30. The pre-treatment exhaust gas stream 38 from the pre-treatment reactor 30 consists predominantly of CO₂, H₂O, CO, H₂, and hydrocarbons from the partial or full devolatilization of the treated secondary solid material 2. The treated secondary solid material 2 and pre-treatment exhaust gas stream 38 is introduced into the packed moving bed reactor 10 with primary solid material 4 for full conversion to CO₂ and H₂O.

In an embodiment, the pre-treatment reactor 30 includes the secondary solid material 2 and a solid agitation agent 32. The particle size of the solid agitation agent 32 is dependent on its particle density. Generally, the solid agitation agent 32 particle size and/or density should be large enough such that its corresponding terminal velocity is greater than the terminal velocity of the secondary solid material 2 under the same gas viscosity and density. Thus, the gas velocity in the pre-treatment reactor 30 is at the fluidizing regime of the solid agitation agent 32.

The solid agitation agent 32 is retained in pre-treatment reactor 30 during operation and thus is capable of operation without continuous replenishment or delivery.

In an embodiment, the solid agitation agent 32 comprises at least one of the oxides of Fe, Ca, Al, Si, Mg, Ti, and Zn.

In some embodiments, the solid agitation agent 32 serves to capture contaminants commonly present in solid fuels such as heavy metals, sulfur, and alkali materials. For example, Al and Si based materials are capable of capturing alkali materials such as Na and K. It is desirable to remove alkali materials such as Na and K because they may foul downstream processing equipment such as heat exchangers. In further embodiments, Ca and Zn based materials are capable of capturing sulfur based contaminants. Removal of sulfur based contaminants helps alleviate production of sulfur dioxide and other regulated emissions.

In an embodiment, the pre-treatment reactor 30 combines the gaseous agent 36, the solid agitation agent 32, and the secondary solid material 2 at elevated temperatures to eliminate or reduce the agglomeration tendencies present in secondary solid material 2, such as caking coals. The pre-treatment reactor 30 operates above the softening temperature of the secondary solid material 2 and below its expected gasification temperature. While the softening and gasification temperature of coal may vary with differing types of coal, the softening temperature of coal is generally between approximately 300° C. and approximately 500° C. and the gasification temperature of coal is generally between approximately 700° C. and approximately 900° C. In an embodiment the pre-treatment reactor 30 operates between 300° C. to 700° C.

In one or more embodiments, the pre-treatment reactor 30 operates at slightly greater than ambient pressure, 1 atm absolute, or elevated pressures. For example, in an embodiment the pre-treatment reactor 30 operates between approximately 1.0 atm and approximately 1.5 atm. The pre-treatment reactor 30 operates at slightly higher pressure than the packed moving bed reactor 10 and the regeneration reactor 20. The maximum operating pressure limitation is dependent on the operating temperature of pre-treatment reactor 30 and its material of construction.

The secondary solid material 2 residence time requirement in the pre-treatment reactor 30 is dependent on the particle size and composition of the secondary solid material 2 as well as the pre-treatment reactor 30 operating temperature and pressure. For example, if pretreating bituminous coals at 300° C., several minutes to hours may be needed to remove the caking effect and pretreat the coal. However, if the same coal is pretreated at 600° C. to 700° C., the necessary residence time to remove the caking effect and pretreat the coal may drop to the order of several seconds. In specific embodiments, the residence time of the secondary solid material 2 can be less than approximately 1 second to greater than approximately 30 minutes. In further embodiments, the residence time of the secondary solid material 2 is between approximately 1 second and approximately 1 minute. In still a further embodiment, the residence time of the secondary solid material 2 is between approximately 1 minute and approximately 10 minutes. In yet still a further embodiment, the residence time of the secondary solid material 2 is between approximately 10 minutes and approximately 30 minutes.

In another embodiment, the recycled product gas from the packed moving bed reactor 10 is used as the gaseous agent 36 for the pretreatment of the secondary solid material 2.

In various embodiments, the volatile gas generated from the pre-treatment reactor 30 and the CO₂ containing gas introduced from the bottom of the fluidizing chamber 6 of the pre-treatment reactor 30 create the pre-treatment exhaust gas stream 38 and is used to transport treated secondary solid material 2 into the packed moving bed reactor 10. In an embodiment, the secondary solid material 2 passes through the pre-treatment reactor 30 in an entrained mode through the fluidized bed of solid agitation agents 32 into transport line 9. The gas velocity in fluidizing chamber 6 is greater than the terminal velocity of the secondary solid material 2. The gas velocity in fluidizing chamber 6 is also greater than the minimum fluidization velocity and less than the terminal velocity of the solid agitation agent 32. Transport line 9 is designed with a gas velocity high enough to prevent sedimentation of the treated secondary solid material 2.

In an embodiment, the treated secondary solid material 2 is introduced toward the middle of packed moving bed reactor 10 using the pre-treatment exhaust gas stream 38 comprising the combined volatiles generated in fluidizing chamber 6 of the pre-treatment reactor 30 and CO₂ containing gaseous agent 36 as the carrier gas.

In various embodiments the gas velocity in fluidizing chamber 6 is greater than the minimum fluidization velocity of both the solid agitation agent 32 and the secondary solid material 2 as well as less than the terminal velocity of the secondary solid material 2. An overflow pipe from fluidizing chamber 6 carries the treated secondary solid material 2 into transport line 9.

Referring to FIG. 16, in further embodiments, the treated secondary solid material 2 is separated from the pre-treatment exhaust gas stream 38 generated in the pre-treatment reactor 30. The treated secondary solid material 2 is transported to the packed moving bed reactor 10 with a separate carrier gas 40. The pre-treatment exhaust gas stream 38 from the pre-treatment reactor 30 is introduced into the packed moving bed reactor 10 either at the top section through line 9a, at the bottom section through line 9b, or through a combination thereof. If exhaust gas diversion to line 9a and 9b is utilized, a conventional diverting method, such as a 3-way valve, may used to provide user directed control of the pre-treatment exhaust gas stream 38.

In accordance with FIGS. 15 and 16, embodiments of the system 100 convert carbonaceous fuel into a gaseous exhaust stream predominantly comprising CO₂ and H₂O. The secondary solid material 2 in the form of a carbonaceous fuel is provided to the fluidizing chamber 6 of the pre-treatment reactor 30 by a lock hopper system 34, for example. The pre-treatment reactor 30 acts to prevent agglomeration of the secondary solid material 2. The solid agitation agent 32 in the pre-treatment reactor 30 fluidizing chamber 6 is maintained in a fluidized regime by a provided gaseous agent 36 split from the gaseous exhaust stream exiting the system 100. The secondary solid material 2 is then transported into the packed moving bed reactor 10 with a motive force provided by the pre-treatment exhaust gas stream 38. The secondary solid material 2 is specifically provided into the packed moving bed reactor at the recessed zone 150 by the secondary solid inlets 140. The secondary solid material 2 then is integrated with the primary solid material 4. The primary solid material 4 is chemically reduced and oxidizes the secondary solid material 2 to produce CO₂ and H₂O. The reduced primary solid material 4a is then transferred to the regeneration reactor where the reduced primary solid material 4a is mixed with air, or other oxygen containing gas. The reduced primary solid material 4a is re-oxidized to create the regenerated primary solid material 4b which is recycled back into the packed moving bed reactor 10 to oxidize additional secondary solid material 2.

It will be apparent to those skilled in the art that various modifications and variations can be made to the embodiments described herein without departing from the spirit and scope of the claimed subject matter. For example, a single or multiple packed moving bed reactors 10 may be connected in series, in parallel, or a combination thereof. Thus it is intended that the specification cover the modifications and variations of the various embodiments described herein provided such modification and variations come within the scope of the appended claims and their equivalents.

1. A system comprising a packed moving bed reactor and a regeneration reactor downstream of the packed moving bed reactor,
the packed moving bed reactor comprises
a primary solid introduction section configured to receive a primary solid material operable to be reduced in the packed moving bed reactor,
a primary solid constriction section downstream of the primary solid introduction section, the primary solid constriction section having an outer wall,
a secondary solid inlet, and
a mixing section for the primary solid material and secondary solid material downstream of the primary solid constriction section, the mixing section having an inner wall; wherein
the primary solid constriction section projects into the mixing section and forms a recessed zone defined by a volume between the outer wall of the primary solid constriction section and the inner wall of the mixing section, wherein the recessed zone has a cross-sectional area equal to about 25% to about 75% of a cross-sectional area of the mixing section immediately downstream of the recessed zone;
the secondary solid inlet disposed adjacent or inside the recessed zone, the secondary solid inlet being configured to deliver the secondary solid material into the packed moving bed reactor at the recessed zone; and
the regeneration reactor is operable to regenerate the primary solid material reduced in the packed moving bed reactor.

2. The system of claim 1 further comprising a recycle loop configured to deliver regenerated primary solid material back to the primary solid introduction section.

3. The system of claim 1 wherein the regeneration reactor comprises one or more reactors selected from the group consisting of a fluidized bed reactor, a moving bed reactor, rotary kiln, a series of fluidized bed in co-current or counter current flow.

4. The system of claim 1 wherein a cross-sectional area of the primary solid constriction section is less than a cross-sectional area of the mixing section.

5. (canceled)

6. The system of claim 1, wherein the primary solid constriction section is an annular ring offset from the inner wall of the mixing section such that the recessed zone is an annular region around the periphery of the packed moving bed reactor.

7. The system of claim 1, wherein the mixing section comprises a first polygonal cross section and the primary solid constriction section comprises a second polygonal cross section.

8. The system of claim 7, wherein the first polygonal cross section of the mixing section and the second polygonal cross section of the primary solid constriction section are of equal order.

9. The system of claim 1, wherein the primary solid constriction section comprises multiple diplegs.

10. The system of claim 1, wherein the mixing section comprises suspended baffles, wall baffles, or suspended baffles and wall baffles downstream of the secondary solid inlet, the suspended baffles and wall baffles being configured to radially mix the primary solid material and the secondary solid material.

11. The system of claim 10, wherein the total cross sectional area of the suspended baffles and wall baffles is equal to about 25% to about 200% of the cross sectional area of the mixing section.

12. The system of claim 1, wherein
the cross-sectional area of the primary solid constriction section is equal to or less than a cross-sectional area of the primary solid introduction section.

13. The system of claim 1, wherein
a cross-sectional area of the mixing section is greater than or equal to a cross sectional area of the primary solid introduction section.

14. The system of claim 1, wherein the secondary solid inlet is operable to deliver the secondary solid material by utilizing a carrier gas comprising at least one of CO, CO₂, H₂, H₂O, CH₄, N₂, O₂, He, Ar, and other carbonaceous gases.

15. The system of claim 1, further comprising a pre-treatment reactor disposed upstream of the packed moving bed reactor, the pre-treatment reactor being configured to fluidize and/or reduce agglomeration in the secondary solid material.

16. The system of claim 15, wherein the pre-treatment reactor is at least one fluidized bed reactor.

17. (canceled)

18. (canceled)

19. The system of claim 15, wherein the pre-treatment reactor comprises one or more fluidizing agents selected from the group consisting of a solid agitation agent, a gaseous agent or both.

20. The system of claim 19, wherein the gaseous agent comprises a recycled product gas from the packed moving bed reactor.

21. (canceled)

22. (canceled)

23. The system of claim 19, wherein the solid agitation agent is configured to assist fluidization of the secondary solid material.

24. The system of claim 23, wherein and the solid agitation agent is also configured to remove Na and K.

25. (canceled)

26. A system comprising a packed moving bed reactor and a regeneration reactor downstream of the packed moving bed reactor,
the packed moving bed reactor comprises
a primary solid introduction section configured to receive a primary solid material operable to be reduced in the packed moving bed reactor,
a primary solid constriction section downstream of the primary solid introduction section, the primary solid constriction section having a plurality of suspended baffles affixed to a plurality of secondary solid inlets, and
a mixing section for the primary solid material and secondary solid material downstream of the primary solid constriction section; wherein
the plurality of suspended baffles form a recessed zone defined by a volume within the plurality of suspended baffles, wherein the recessed zone has a total cross-sectional area equal to about 25% to about 200% of a cross-sectional area of the mixing section immediately downstream of the primary solid constriction section;
the plurality of secondary solid inlets disposed adjacent or inside the recessed zone of each suspended baffle and configured to support the plurality of suspended baffles, the plurality of secondary solid inlets being configured to deliver the secondary solid material into the packed moving bed reactor at the recessed zone; and
the regeneration reactor is operable to regenerate the primary solid material reduced in the packed moving bed reactor.

27. (canceled)

28. (canceled)

29. (canceled)

30. (canceled)

31. (canceled)
